(19) United States
(12) Patent Application Publication
(10) Pub. No.: US 2018/0176222 A1
(43) Pub. Date: Jun. 21, 2018

(54) USER FRIENDLY TWO FACTOR AUTHENTICATION

(71) Applicants: Raghav Bhaskar, New Delhi (IN); Kunal Sharma, Delhi (IN)

(72) Inventors: Raghav Bhaskar, New Delhi (IN); Kunal Sharma, Delhi (IN)

(21) Appl. No.: 15/740,648

(22) PCT Filed: Jun. 22, 2016
(86) PCT No.: PCT/IB2016/053702

§ 371 Date: Dec. 28, 2017

(30) Foreign Application Priority Data
Jun. 30, 2015 (IN) 1967/DEL/2015

(51) Int. Cl. H04L 29/06; H04L 9/08; H04L 9/32; H04L 9/14; G06Q 20/40; G06Q 20/36

(52) U.S. Cl. CPC H04L 63/0884; G06Q 2220/00; H04L 63/0861; H04L 9/085; H04L 9/0863; H04L 9/3228; H04L 63/0815; H04L 63/0838; H04L 9/14; G06Q 20/401; G06Q 20/363; H04L 2463/082; H04L 63/0435; H04L 63/0442; H04L 63/083

(57) ABSTRACT

A user friendly two factor authentication method and system for a user is disclosed. In an embodiment the system includes a user device, an authentication server, a network interconnecting the user device and authentication server and software on the user device and authentication server that cooperates to first register the user by storing first key share K1 of an authentication key K on the user device and storing a second key share K2 of K blinded by a user chosen password on the authentication server, and then authenticate the user by implementing a protocol where the user's knowledge of the password and the possession of the user device is used to derive the key K for authentication. Thus, the two factors are checked in one integrated protocol, thereby requiring no additional work or change in user behavior.

### TECHNICAL FIELD

The present application relates generally to authentication technology. In particular, the application relates to system and method for performing two factor authentication in one integrated protocol.

### BACKGROUND

Two factor authentication (2FA) is a system to strengthen user authentication and overcome many of the weaknesses associated with simple password based authentication systems. Such two factor authentication combines pre-determined factors, including “something you know” (such as password, PIN number, etc.), “something you have” (such as token, access card, etc.) or “something you are” (such as fingerprint, iris scan etc.). 2FA authentication systems provide an additional level of security and reliability over simple password based authentication systems. However, two factor authentication (2FA) has found limited user adoption and are mostly limited to financial systems where they are mandated by regulation. A large number of web applications now provide an option to users to implement two factor authentication (2FA) however they continue to be plagued by extremely limited user adoption. The key reason why 2FA systems have found limited user adoption despite being more secure and reliable than password authentication systems is the cumbersomeness and inconvenience associated with such systems.

Many 2FA systems utilise one time passwords (OTPs), hardware tokens, software tokens etc. to provide the user with an additional factor of authentication. The OTP may be delivered to the user on her smartphone over a channel like SMS or generated with a device like RSA SecurID or a software application like Google Authenticator. This means that the user needs to carry an additional device all the time and use the token from such device for authenticating. This change in login behavior and the additional hassle involved is the key reason behind limited adoption and popularity of such systems. Some other 2FA systems require the need for specialized hardware (like fingerprint scanner, iris scanner etc.) which may not be present in several authentication scenarios.

Moreover, design of existing two factor authentication systems is mostly serial implementation of one factor of authentication followed by the other, for example, requiring the user to enter a six digit OTP once he/she has entered the password. Apart from increasing the user's inconvenience and authentication time, it permits independent and simultaneous attacks on the underlying systems, implying that the effort of attackers to break an overall system is effectively increased to breaking a more complicated system out of two systems rather than both the systems. For instance, an attacker can in parallel make efforts to retrieve a password (using say Dictionary, Phishing attacks etc.) and also break the system to generate the OTP (breaking into the “seed” storage system for OTPs, compromising user devices etc.). Ideally a system using multiple factors of authentication should grant access when both factors are correctly provided else it should provide no information about the correctness of either factor.

### SUMMARY

Disclosed herein are methods and systems for two factor authentication for a user for dramatically improving the user experience and removing the friction associated with a typical two factor authentication process while increasing the security. The two factors are checked in one integrated protocol, thus requiring no additional work or change in behavior for the user during the authentication step. Also, security is strengthened as access is granted when both factors are correctly provided else no information about correctness of either factor is provided.

According to a first aspect of the invention, disclosed is a method for providing two factor authentication in one integrated protocol using a system comprising a user device, an authentication server, and a network interconnecting the user device and authentication server. The method comprises registering the user by receiving a password from the user; generating a key K composed of two key shares K1and K2; storing key share K1 on the user device and sending authentication token for key K and key share K2 blinded by the password to the authentication server; and authenticating the user by receiving a password from the user, retrieving key share K2 using the password received from the user and the blinded key share of K2, combining the retrieved key share K2 with stored key share K1 to compute key K, and implementing a standard authentication protocol using key K and authentication token for key K. In one embodiment, the standard authentication protocol is a public key protocol. In a second embodiment, the standard authentication protocol is a public key zero knowledge protocol. In an alternate embodiment, the standard authentication protocol is a symmetric key protocol.

According to an aspect of the invention, a system for providing two factor authentication for a user is disclosed. The system comprises: a user device; an authentication server; a network interconnecting the user device and the authentication server; software on the user device and the authentication server that cooperates to first register the user by storing first key share K1 of an authentication key K on the user device and storing a second key share K2 of K blinded by a user chosen password on the authentication server, and then authenticate the user by implementing a standard key based authentication protocol between the user and the authentication server using the authentication key K. This authentication key K in turn is computed by combining key share K1 stored on the user device with key share K2 derived using the password received from the user and the blinded key share of K2 received from the authentication server.

In one embodiment, the authentication server controls access to a plurality of applications, wherein the authentication server permits the user to access any of the plurality of applications if the user is authenticated, thereby providing a single sign-on (SSO) feature. In an embodiment, the user device is a smartphone. In another embodiment, the two factor authentication is used to secure a wallet application on the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system architecture in accordance with various embodiments and implementations;

FIG. 2 is an event trace diagram illustrating the implementation of the method of two factor authentication in accordance with an embodiment;

FIG. 3 is an event trace diagram elaborating the step of registration of a user in the two factor authentication in accordance with an embodiment;

FIG. 4 is an event trace diagram elaborating the step of authentication of a user in the two factor authentication in accordance with an embodiment;

FIG. 5 illustrates an example authentication protocol flow between a user device and an authentication server for a one-time registration, in accordance with an embodiment;

FIG. 6 illustrates an example authentication protocol flow between a user device and an authentication server during login, in accordance with an embodiment;

FIG. 7 is an event trace diagram elaborating the step of registration of an additional user device in the two factor authentication method in accordance with an embodiment;

FIG. 8 is a block diagram of an electronic device, in accordance with an embodiment.

### DETAILED DESCRIPTION OF THE DRAWINGS

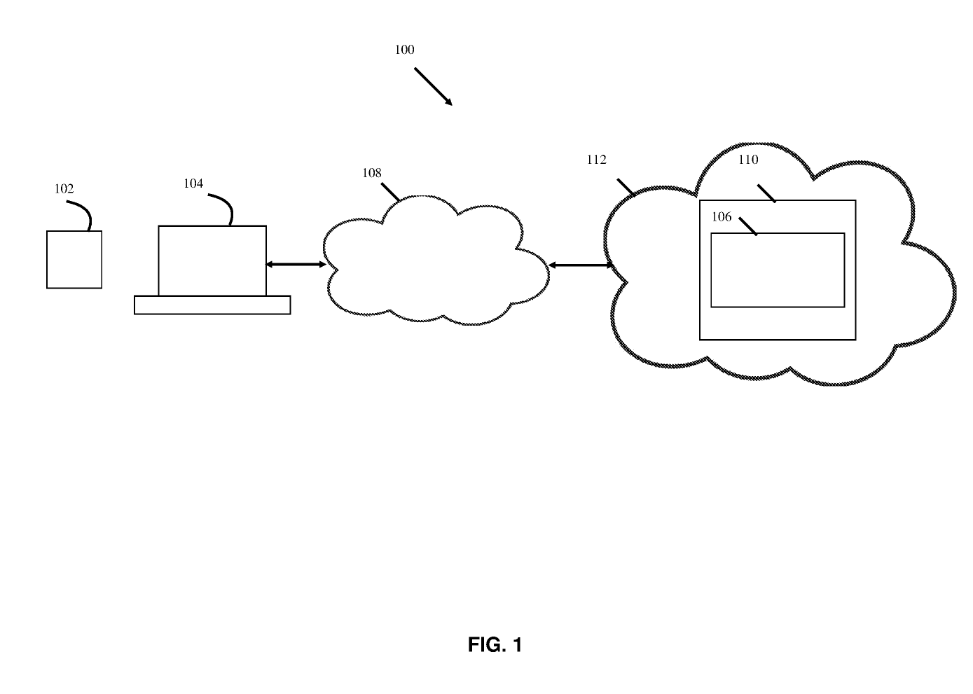

FIG. 1 illustrates an example system architecture 100, in which various embodiments of the present technology may be practiced. The system architecture 100 includes user 102 with a user device 104, an authentication server 106, and a network 108 interconnecting user device 104 and authentication server 106. Examples of user devices 104 include computers, mobile devices, tablets, laptops, palmtops, hand held devices, smartphones, wearables like smartwatches, smart glasses or smart fitness trackers, telecommunication devices, Internet of things (IoT devices), personal digital assistants (PDAs) or any other computing terminal. Authentication server 106 can be a cloud-based server comprising one or more host server machines 110 hosted on cloud or inside the premises of an enterprise network. Network 108 may be a private network, such as an enterprise intranet, a public network, such as the Internet or combinations thereof, and can utilize a variety of networking protocols now available or later developed including, but not limited to TCP/IP based networking protocols. The network can include wired networks, wireless networks, Ethernet AVB networks, or combinations thereof. The wireless network can include a cellular telephone network, an 802.11, 802.16, 802.20, 802.1Q or WiMax network.

In accordance with an embodiment, software on the user device 104 and the authentication server 106 cooperates to first register the user by storing first key share K1 of an authentication key K on user device 104 and storing a second key share K2 of K blinded by a user chosen password pw on the authentication server 106, and then authenticate the user device 102 by implementing a protocol whereby the user's knowledge of the password pw and the possession of the user device 104 is used to derive the key K for authentication.

In one embodiment, the authentication server 106 controls access to a plurality of applications, so as to permit the user 102 to access any of the plurality of applications once the user is authenticated, thereby providing a single sign-on (SSO) feature. Such applications may be hosted on host server machines 110 or on cloud 112. Examples of such applications include Email, Storage, Collaboration, File sharing, Social network, Customer relationship management (CRM), Human resource management and so on.

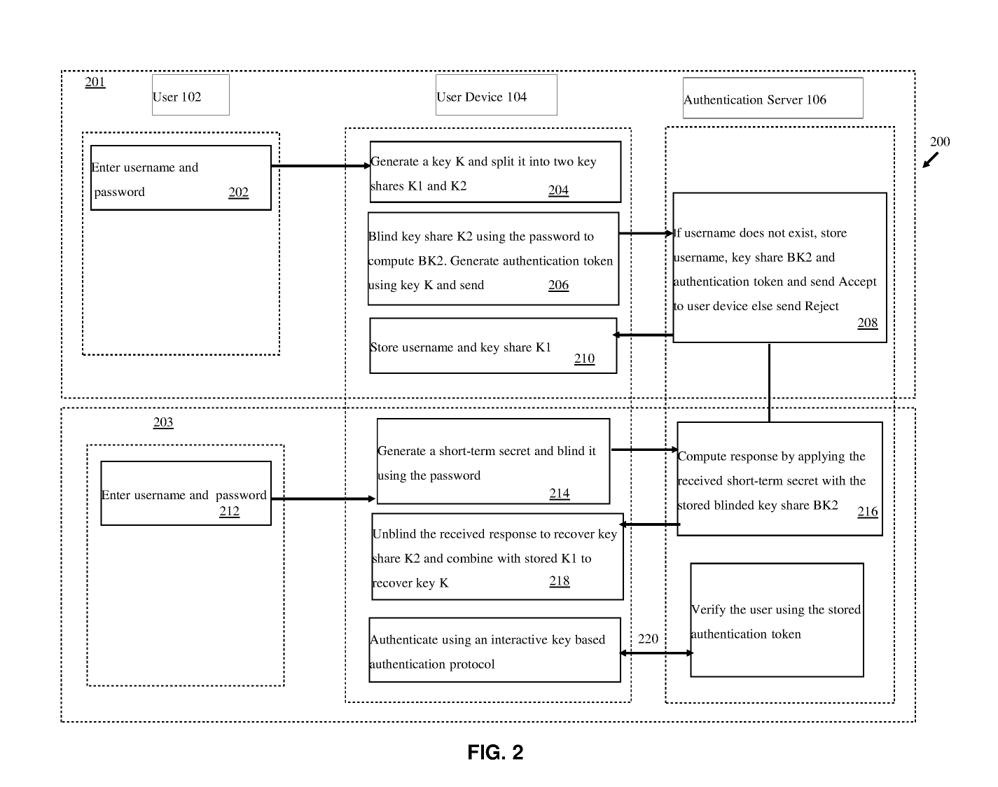

FIG. 2 is an event trace diagram illustrating the implementation of method 200 of two factor authentication in accordance with an embodiment. Method 200 has two stages registration 201 and authentication 203 illustrated as dashed boxes. Registration 201 illustrates all the method steps involved in registering a user 102 on user device 104 and authentication 203 illustrates the method steps involved in authenticating the registered user 102. FIG. 2 also illustrates different steps that are performed by user 102, user device 104 and authentication server 106. In the registration stage 201, the user 102 chooses a username and password with which to register and enters the chosen username and password in the user device 104 at step 202. At step 204, a random key K is generated by the user device 102 and split into two key shares K1 and K2. K and K₁ are random numbers that are chosen and K₂ is derived from a relationship between K, K₁, so that: K=K₁.K₂

At step 206, key share K2 is blinded using the password entered by the user to compute BK2 and an authentication token is generated using key K. Further at step 206, username, key share BK2 and the authentication token are sent by the user device 104 to the authentication server 106. The authentication server 106 checks if the username already exists. If the username does not exist, the authentication server 106 stores the received username, key share BK2 and the authentication token and sends an Accept message to the user device 104 else it stores nothing and sends a Reject message to the user device at step 208. At step 210, on receiving an Accept message from the authentication server 106, username and key share K1 are stored on the user device 104 else registration is deemed unsuccessful. This sequence of steps completes the registration for the user 102 on the user device 104.

In the authentication stage 203, at step 212 the user 102 enters the username and the password chosen by user 102 while registering on user device 104 in the registration stage 201. At step 214, the user device 104 generates a short term secret, blinds it using the password and sends it to the authentication server 106. At step 216, the authentication server 106 computes a response by applying the received blinded short-term secret with the stored blinded key share BK2 and sends the response back to the user device 104. At step 218, the received response is unblinded to recover key share K2 and combined with stored K1 to recover key K. At step 220, the user 102 is authenticated by implementing a standard interactive authentication protocol using key K and an authentication token for key K.

The standard interactive authentication protocol may be a public key protocol like for example the Schnorr identification protocol or a symmetric key protocol like for example the keyed message authentication code protocol. In one embodiment, the standard interactive authentication protocol is a public key zero knowledge protocol. It will be evident that any public or symmetric key protocol may be utilised once the key K has been generated by the method disclosed herein. The method disclosed herein thus utilises both factors—the user's knowledge of password and possession of user device to derive key K which is then used for authenticating the user.

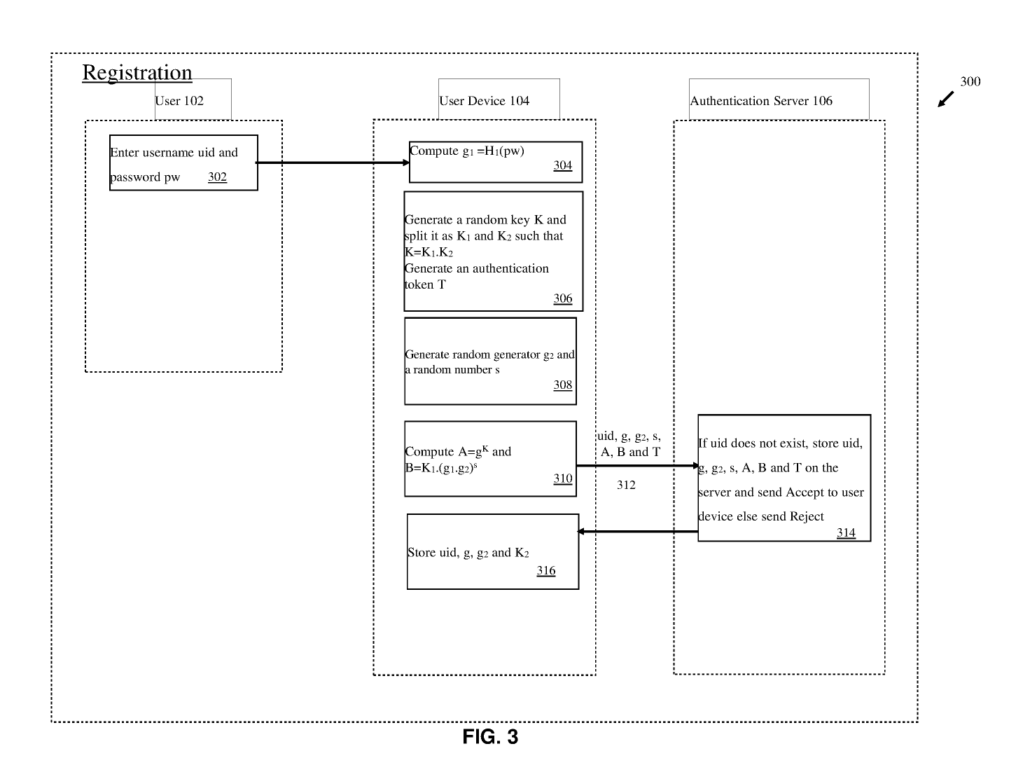

FIG. 3 is an event trace diagram elaborating the step of registration of a user in the two factor authentication in accordance with an embodiment. At step 302, the user 102 chooses a username uid and a password pw and inputs the same on the user device 104. At step 304, the user device 104 performs a hash function on the password pw as shown below in equation (1) to compute g₁:

g₁=H₁(pw) (1)

where H₁ is a first hash function that maps strings of arbitrary length into mod p numbers, and p is a modulo parameter mentioned in the Digital Signature Standards published by FIPS at http://nvlpubs.nist.gov/nistpubs/FIPS/NIST-FIPS-186-4.pdf. g is a generator published in the same standard.

At step 306, the user device 104 generates a random key (K), for example a 128 bit random string. The key K is further split into a first key share (K₁) and a second key share (K₂). K and K₁ are random numbers that are chosen and K₂ is derived from K and K₁. User device 104 also generates the authentication token T for key K at step 306. At step 308, the user device 104 generates random numbers, for example a second random generator g₂ of order p and a random number s modulo q where q is again a modulo parameter mentioned in the Digital Signature Standards published by FIPS at http://nvlpubs.nist.gov/nistpubs/FIPS/NIST-FIPS-186-4.pdf. At step 310 the user device 104 computes A=g^{K} modulo p and B=K₁.( g ₁.g₂)^{s} modulo p.

At step 312, user device 104 transmits uid, g, g₂, s, A, B and T to the authentication server 106. At step 314, the authentication server 106 stores the uid, g, g₂, s, A, and B and sends an Accept message to the user device 104, if the username uid does not exist already, else authentication server 106 sends a Reject message. At step 316, the user device 104 stores uid, g, g₂, and K₂ if it received an accept from the authentication server. In the above description, the g, g₁, g₂, are numbers modulo p and s, K, K₁, K₂ are numbers modulo q.

In one embodiment, key K is split into two key shares K1 and K2 so that K=K1.K2. In alternate embodiments, key K may be split as K=K1⊗K2. It will be understood that K could be split into key shares K1 and K2 using other secret sharing protocols for example Shamir's secret sharing protocol. In one embodiment, the authentication token T for key K is the same as A=g^{K} mod p. In another embodiment, the authentication token T for key K is H2(T) where H2 is another hash function which outputs elements of size p. In other embodiments, the authentication token T for key K may depend on the standard authentication protocol that is chosen for key K at Step 220 of FIG. 2.

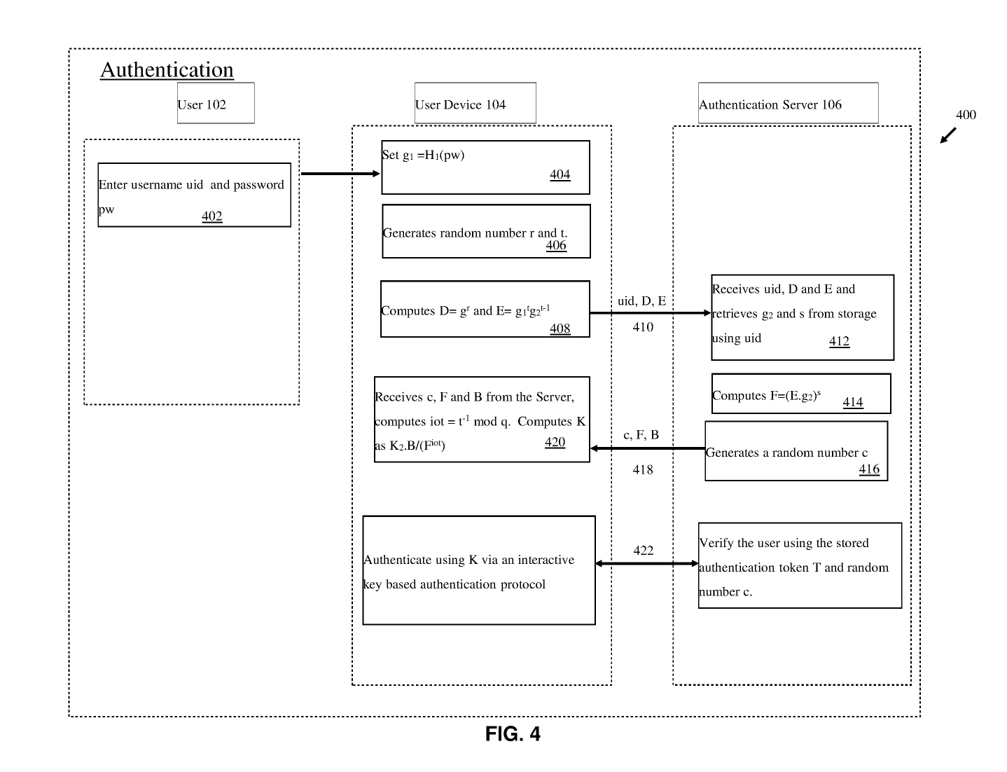

FIG. 4 is an event trace diagram elaborating the step of authentication of a user in the two factor authentication method in accordance with an embodiment. At step 402, the user 102 inputs the username uid and recalls the password pw that the user 102 had initially registered, for example at step 302 of FIG. 3. At step 404, the user device 104 performs a hash function on the password pw as shown below in equation (2) to compute g₁, which is similar to the equation (1):

g₁=H₁(pw) (2).

At step 406, the user device 104 generates random numbers, for example a random number r and a random number t, both modulo q. At step 408, the user device 104 computes g^{r} modulo p and assigns it to D and computes g₁^{t} g₂^{t-1} modulo p and assigns it to E. The username uid, D and E are further transmitted to the authentication server 106 at step 410.

At step 412, the authentication server 106 receives the username, D and E and retrieves g₂ and s from storage of the authentication server 106 using the username uid. At step 414 the authentication server 106 computes F which is a number mod p. F is computed based on equation (3):

F=(E.g₂)^{s} (3)

At step 416, the authentication server 106 generates a random number c, where c is a number modulo q. At step 418, the numbers c, F and B are transmitted by the authentication server 106 to the user device 104. At step 420, the user device 104 receives the numbers c, F and B from the authentication server 106 and determines an inverse of t (iot) as given in equation (4) below:

iot=t⁻¹ mod q (4)

Further at step 420, the user device 104 determines K as given below in equation (5):

K=K₂.B/(F^{iot}) mod q (5)

At step 422, the key K is used for authentication via an interactive key based authentication protocol and the user is verified using the stored authentication token T and random number c.

In one embodiment, the two factor authentication technology disclosed herein may be used in conjunction with a standard federated single sign-on (SSO) system for providing authentication for the multiple applications based either on the cloud or on-premise. Examples of such applications include email, storage, collaboration, file sharing, social network, CRM, HRM etc. Such federated SSO systems are deployed in enterprises and authenticate an end user for all applications the user has been given rights to and eliminate further prompts for authentication when the user switches applications during an authenticated session. SSO systems are typically based on open standards, such as Security Assertion Markup Language (SAML), OAuth and OpenID, and used by enterprises to reduce user fatigue resulting from providing different username and password combinations. In such an implementation, the user is able to access all the different applications of the SSO system in a secure and frictionless manner without having to use any additional hardware or software tokens while accessing such applications.

In another embodiment, the two factor authentication technology disclosed herein may be combined with an additional third authentication factor representing what the user is. For example, the technology may be combined with biometric information to add an additional layer of security for the user. This biometric information may include, but is not limited to: fingerprints, facial recognition, voice recognition, retinal scans, palm prints, vein patterns in the hand and/or eye and so on. In different embodiments, the third authentication factor may include one time password (OTP) delivered through SMS or push notification or generated by an authenticator app like Google authenticator or a USB key like Yubikey.

In another embodiment, the key K derived at step 420 is utilised to derive several other cryptographic keys. These keys could be part of a public key crypto system (Kes, Kep) or a symmetric key crypto system (Ke) and could be used to encrypt the user's sensitive data. It will be evident to one skilled in the art that once key K has been derived using the two factor authentication method disclosed herein, the cryptographic keys could be derived through any standard key derivation functions. The key advantage of this approach is that the derived encryption keys need not be stored in any place nor have to be memorized by the user; once the user is authenticated, the keys are derived automatically and are available for encrypting or decrypting data as long as the user is logged in. In case of compromise of the user's device or the authentication server, all user keys still remain secure as they are not stored in one place completely. Thus, the two factor authentication method disclosed herein also provides an efficient public key management system.

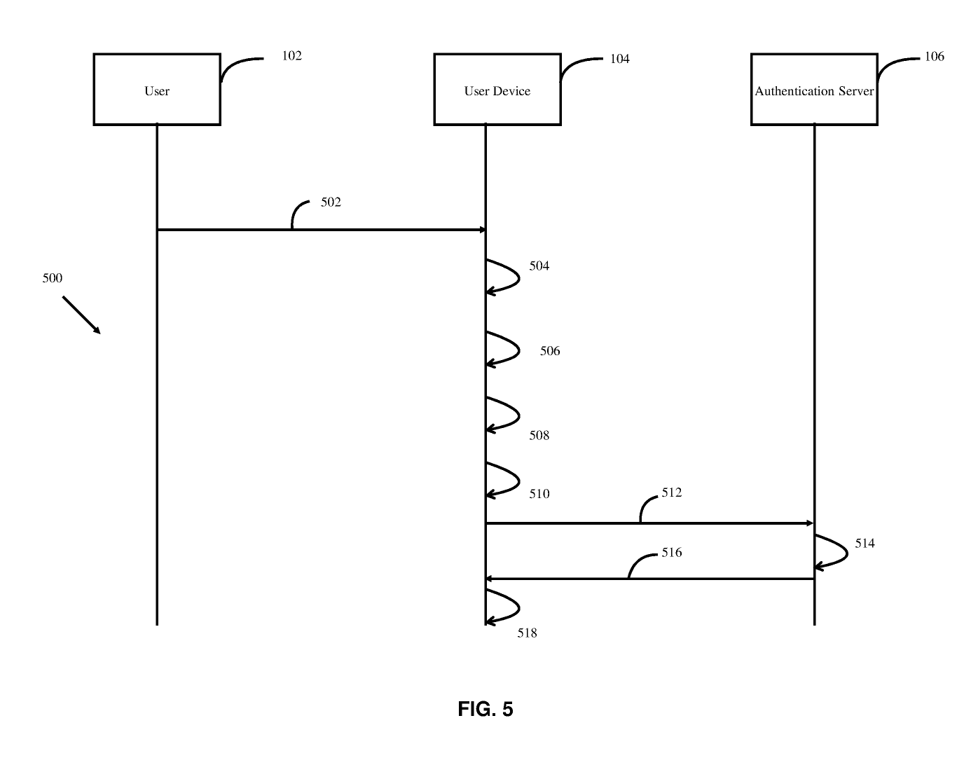

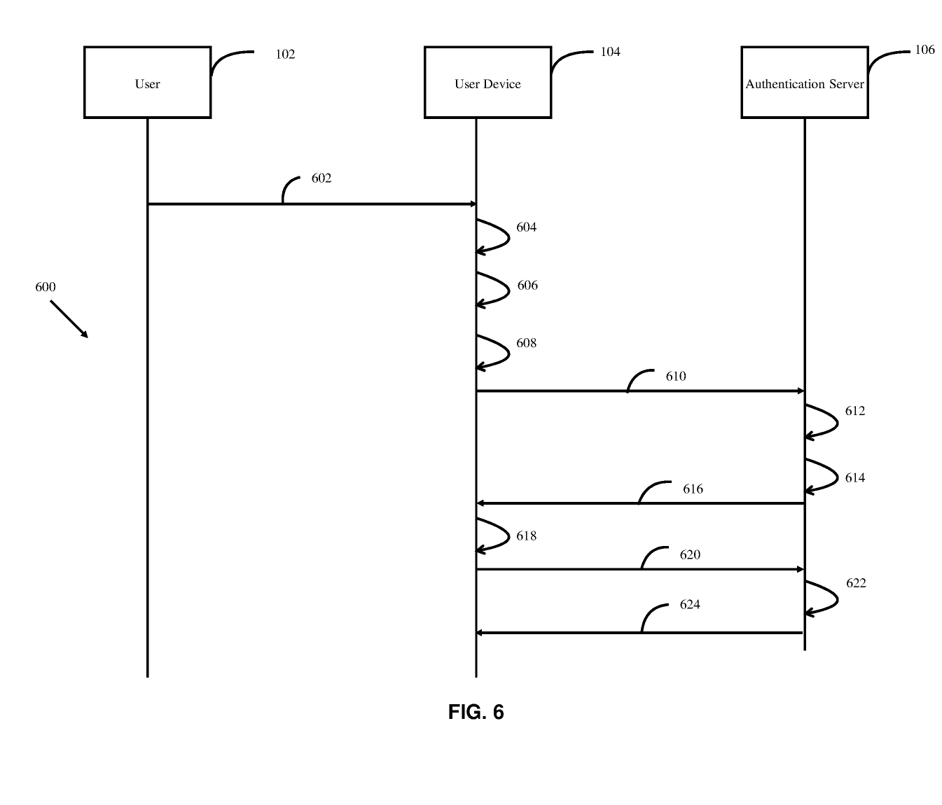

Example embodiments of authentication protocol flow between the user device 104 and the authentication server 106 using the disclosed two-factor user authentication method is explained with reference to FIGS. 5 and 6. FIGS. 5 and 6 explain the method of two factor authentication disclosed herein with reference to combination with an asymmetric key based authentication protocol, for example Schnorr identification protocol. In different embodiments, the method of two factor authentication disclosed herein may be combined with a symmetric key protocol like for example the keyed message authentication code protocol. It will be evident that any public or symmetric key protocol may be utilised for authentication once the key K has been generated by the method disclosed herein.

Examples of numbers or parameters and protocols used in the present invention are described in publication entitled, “Digital Signature Standard (DSS)” by National Institute of Standards and Technology, published in Federal Information Processing Standards Publication 186-4 on July 2013, which is incorporated herein by reference in its entirety. Referring now to FIG. 5, an example authentication protocol flow 500 between a user device 104 and an authentication server 106 for one-time registration is illustrated, in accordance with an embodiment. User 102 selects user device 104 for registration with authentication server 106. The user 102 chooses a username uid and a password pw and inputs the username uid and the password pw into the user device 104, at step 502. At step 504, the user device 104 performs a hash function on the password pw as shown below in equation (6):

g₁=H₁(pw) (6)

where H₁ is a first hash function that maps strings of arbitrary length into modulo p numbers, as explained earlier.

At step 506, the user device 210 generates a random key (K), for example a 128 bit random string. The key K is further split into a first key share (K₁) and a second key share (K₂). K and K₁ are random numbers that are chosen and K₂ is derived from a relationship between K and K₁.K₂ is given as shown in equation (7), where a multiplication operation is performed between K₁ and K₂:

K=K₁.K₂ mod q (7)

At step 508, the user device 104 generates random numbers, for example a second random generator g₂ and a random number s modulo q. At step 510, the user device 104 computes A=g^{K} mod p and B=K₁.(g₁.g₂)^{s} mod p and then sends uid, g, g₂, s, A and B to the authentication server 106 at step 512. (In this implementation, the role of authentication token T is played by A). At step 514, the authentication server 106 stores the uid, g, g₂, s, A=g^{k}, and B=K₁.(g₁.g₂)^{s}and sends Accept to the user device 104 if the username uid does not exist already else it sends Reject to the user device 104 at step 516. At step 518, the user device 104 stores uid, g, g₂, and K₂, if it receives an Accept. Else the registration is deemed unsuccessful and needs to be re-initiated with a new username

Another authentication protocol is run between the user device 104 and the authentication server 106 when the user 102 tries to login using the user device 104 which was used at the time of registration. An example authentication protocol flow for such authentication is now explained with reference to FIG. 6.

Referring now to FIG. 6, an example authentication protocol flow 600 between the user device 104 and the authentication server 106 during login is illustrated, in accordance with an embodiment. The uid, g, g₂, K₂ is stored in memory of the user device 104 and the uid, g, g₂, s, A, B is stored in memory of the authentication server 106, based on the registration protocol flow of FIG. 5. At step 602, the user 102 inputs the username uid and recalls the password pw that the user 102 had initially registered, for example at step 502 of FIG. 5. At step 604, the user device 104 performs a hash function on the password pw as shown below in equation (8) which is similar to the equation (1):

g₁=H₁(pw) (8)

At step 606, the user device 104 generates random numbers, for example a random number r and a random number t, both modulo q. At step 608, the user device 104 computes D=g^{r} modulo p and E=g₁^{t} g₂^{t-1} modulo p. The uid, D and E are further transmitted to the authentication server 106 at step 610.

At step 612, the authentication server 104 receives uid, D and E, and retrieves g, g2, s, A, and B from storage, and matches the received uid with the uid stored in the memory of the authentication server 106. It computes F based on equation (9):

F=(E.g₂)^{s} mod p (9)

At step 614, the authentication server 106 generates a random number c, where c is a number mod q. At step 616, the numbers c, F and B are transmitted to the user device 104. At step 618, the user device104 receives the numbers c, F and B from the authentication server 106 and determines an inverse oft (iot) as given in equation (10) below:

iot=t₋₁ mod q (10).

Further at step 618, the user device 106 determines K as given below in equation (11):

K=K₂.B/(F^{iot}) mod q (11)

Another random number G is determined based on K determined from equation (11) and is given in equation (12) below:

G=r+c.K mod q (12)

G is further transmitted to the authentication server 106 at step 620. At step 622, the authentication server 106 receives G and further checks if g^{G}.A^{c-c} equals D mod p. If D is equal to g^{G}.A^{-c} mod p, it is determined that the user 102 is authentic, the user device 104 is previously registered, and the password provided by the user 102 is authentic and then an Accept message is sent at Step 624. If D is not equal to g^{G}.A^{-c} mod p it is determined that either the user 102 is not authentic, the user device 104 is not previously registered, or the password provided by the user 102 is not authentic and then a Reject message is sent at Step 624. In the above example, the numbers g, g₁, g₂, are numbers mod p and c, r, s, t, iot, K, G, K₁, K₂ are numbers mod q.

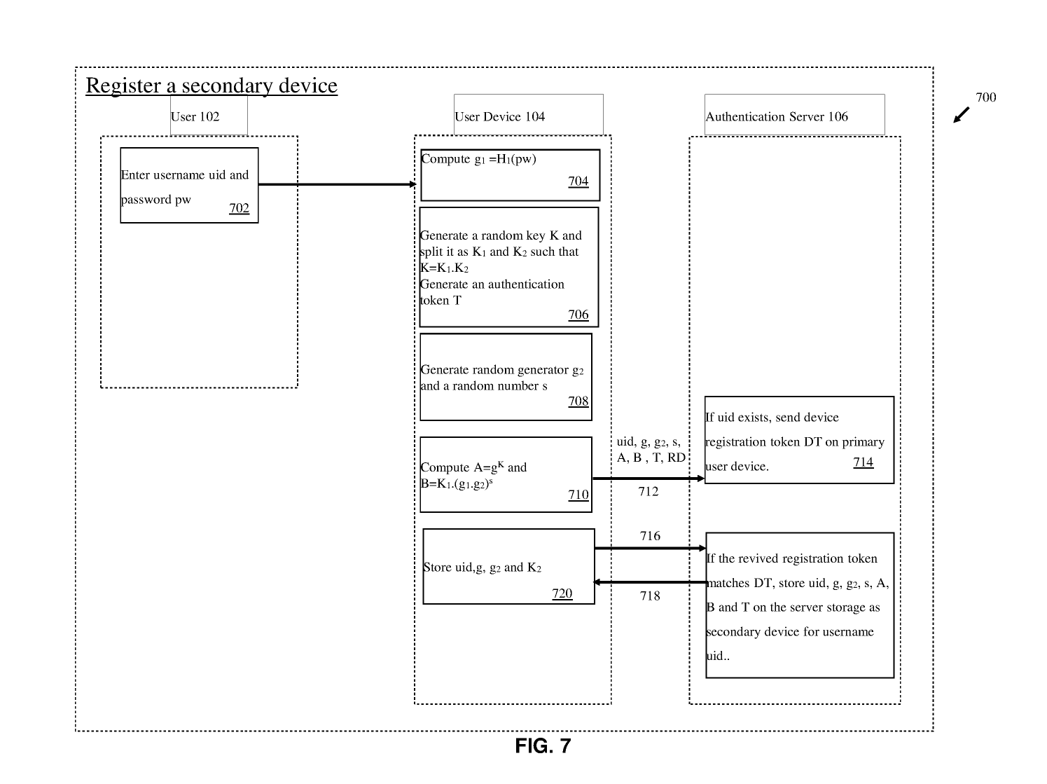

In all the above embodiments, an implementation of the authentication step of the two factor authentication method is described when the user authenticates from the same device as that used at the time of registration. Such a device is referred to as the primary user device of the user. In case where the user possesses multiple devices like a laptop, a tablet and a smartphone, the user can also authenticate itself after registering any such new device as a secondary user device. The user can register as many secondary user devices as required. Each such secondary user device needs to be registered only once and requires the user to demonstrate possession of the primary user device as explained in FIG. 7.

FIG. 7 is an event trace diagram elaborating the step of registration of a user from a device, different from the primary device, in the two factor authentication in accordance with an embodiment. At step 702, user provides the same username uid and a password pw that the user created while registering on the primary user device. At step 704, the secondary user device performs a hash function on the password pw as shown below in equation (13) to compute g₁:

g₁=H₁(pw) (13)

At step 706, the secondary user device generates a random key (K), for example a 128 bit random string. The key K is further split into a first key share (K₁) and a second key share (K₂). K and K₁ are random numbers that are chosen and K₂ is derived from a relationship between K and K₁. The secondary user device also generates the authentication token T for key K. At step 708, the secondary user device generates random numbers, for example a second random generator g₂ and a random number s. At step 710 the secondary user device computes A=g^{K} mod p and B=K₁.(g₁.g₂)^{s}mod p

At step 712, the secondary user device transmits a control message for secondary device registration denoted as RD along with uid,g, g₂, s, A, B and T to the authentication server 106. The control message indicates to the authentication server 106 that the user is looking to register a secondary user device. The authentication server 106 matches the uid received with that stored in the storage and sends a device registration token DT on the primary user device at step 714. The communication of DT to the primary user device can happen in several ways including Short Message Service (SMS), email or inbuilt notification to the user when the user logs in from the primary user device. The user retrieves the token DT from the primary device and sends it to the authentication server via the secondary user device at Step 716. If the received device token matches DT, the authentication server 106 stores uid, g, g₂, s, A=g^{k}, and B=K₁.(g₁.g₂)^{s}, with the existing storage of the user and sends Accept message to the secondary user device else it sends a Reject at Step 718. At step 720, the secondary user device stores uid, g, g₂, and K₂ if it received an Accept from the authentication server 106.

Once the secondary user device has been registered the user can execute the two factor authentication protocol disclosed herein from both primary and secondary user devices. It will be apparent that the user can register as many secondary user devices as required utilizing the method disclosed in FIG. 7.

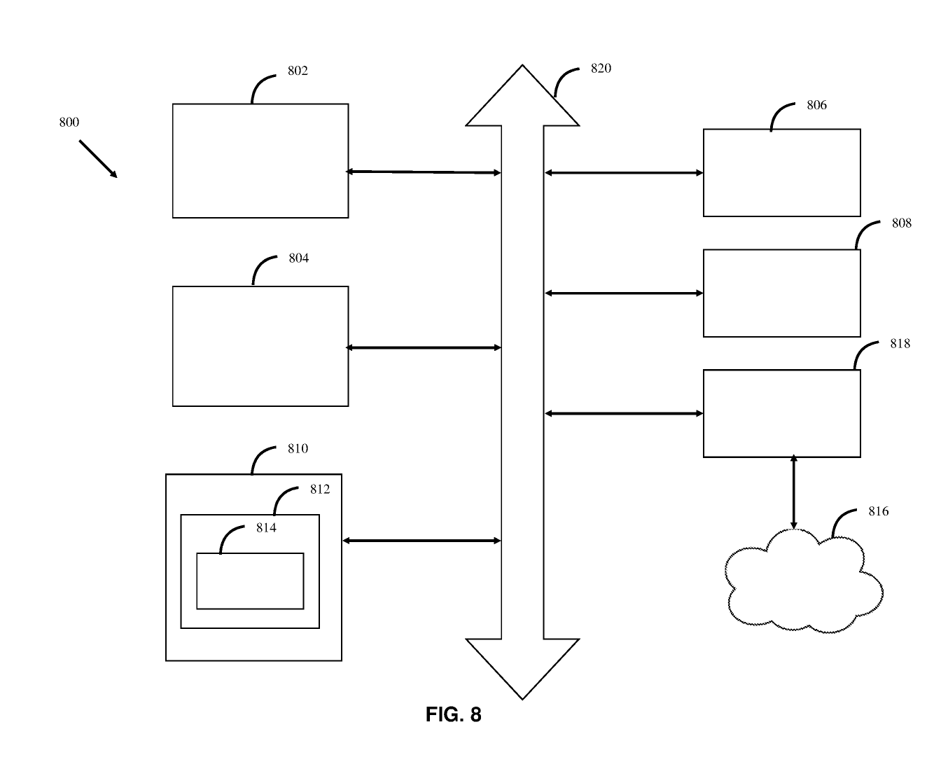

FIG. 8 illustrates a block diagram of an electronic device 800, which is representative of a hardware environment for practicing the present invention. The electronic device 800 can include a set of instructions that can be executed to cause the electronic device 800 to perform any one or more of the methods disclosed. The electronic device 800 may operate as a standalone device or can be connected, for example using a network, to other electronic devices or peripheral devices.

In a networked deployment of the present invention, the electronic device 800 may operate in the capacity of a user device, for example the user device 104 in FIG. 1 or as an authentication server, for example the authentication server 106 of FIG. 1, in a server-client user network environment, or as a peer electronic device in a peer-to-peer (or distributed) network environment. The electronic device 800 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a wearable device (smart watch or glass etc), an Internet of things (IoT) device, a control system, a camera, a scanner, a facsimile machine, a printer, a personal trusted device, a web appliance, a network router, switch or bridge, or any other machine capable of executing a set of instructions (sequential or otherwise) that specify actions to be taken by that machine. Further, while a single electronic device 800 is illustrated, the term “device” shall also be taken to include any collection of systems or sub-systems that individually or jointly execute a set, or multiple sets, of instructions to perform one or more computer functions.

The electronic device 800 can include a processor 802, for example a central processing unit (CPU), a graphics processing unit (GPU), or both. The processor 802 can be a component in a variety of systems. For example, the processor 802 can be part of a standard personal computer or a workstation. The processor 802 can be one or more general processors, digital signal processors, application specific integrated circuits, field programmable gate arrays, servers, networks, digital circuits, analog circuits, combinations thereof, or other now known or later developed devices for analysing and processing data. The processor 802 can implement a software program, such as code generated manually (for example, programmed).

The electronic device 800 can include a memory 804, such as a memory 804 that can communicate via a bus. The memory 804 can include a main memory, a static memory, or a dynamic memory. The memory 804 can include, but is not limited to, computer readable storage media such as various types of volatile and non-volatile storage media, including but not limited to, random access memory, read-only memory, programmable read-only memory, electrically programmable readable-only memory, electrically erasable read-only memory, flash memory, magnetic tape or disk, optical media and the like. In one example, the memory 804 includes a cache or random access memory for the processor 802. In alternative examples, the memory 804 is separate from the processor 802, such as a cache memory of a processor, the system memory, or other memory. The memory 804 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts or tasks illustrated in the figures or described can be performed by the processor 802 executing the instructions stored in the memory 804. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 800 can further include a display unit 806, for example a liquid crystal display (LCD), an organic light emitting diode (OLED), a flat panel display, a solid state display, a cathode ray tube (CRT), a projector, a printer or other now known or later developed display device for outputting determined information. The display 806 can act as an interface for a user to see the functioning of the processor 802, or specifically as an interface with the software stored in the memory 804 or in a drive unit.

Additionally, the electronic device 800 can include an input device 808 configured to allow the user to interact with any of the components of the electronic device 800. The input device 808 can include a number pad, a keyboard, or a cursor control device, for example a mouse, or a joystick, touch screen display, remote control or any other device operative to interact with the electronic device 800.

The electronic device 800 can also include a drive unit 810. The drive unit 810 can include a computer-readable medium 812 in which one or more sets of instructions 814, for example software, can be embedded. Further, the instructions 814 can embody one or more of the methods or logic as described. In a particular example, the instructions 814 can reside completely, or at least partially, within the memory 804 or within the processor 802 during execution by the electronic device 800. The memory 804 and the processor 802 can also include computer-readable media as discussed above.

The present invention contemplates a computer-readable medium that includes instructions 814 or receives and executes the instructions 814 responsive to a propagated signal so that a device connected to a network 816 can communicate voice, video, audio, images or any other data over the network 816. Further, the instructions 814 can be transmitted or received over the network 816 via a communication port or communication interface 818 or using the bus 820. The communication interface 818 can be a part of the processor 802 or can be a separate component. The communication interface 818 can be created in software or can be a physical connection in hardware. The communication interface 818 can be configured to connect with the network 816, external media, the display 806, or any other components in the electronic device 800 or combinations thereof. The connection with the network 816 can be a physical connection, such as a wired Ethernet connection or can be established wirelessly as discussed later. Likewise, the additional connections with other components of the electronic device 800 can be physical connections or can be established wirelessly. The network 816 can alternatively be directly connected to the bus 820.

The network 816 can include wired networks, wireless networks, Ethernet AVB networks, or combinations thereof. The wireless network can include a cellular telephone network, an 802.11, 802.16, 802.20, 802.1Q or WiMax network. Further, the network 816 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 800.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system and methods of the preferred embodiment and variations thereof can be embodied and/or implemented at least in part as a machine configured to receive a computer-readable medium storing computer-readable instructions. The instructions are preferably executed by computer-executable components preferably integrated with a two-factor authentication service and/or a two-factor authentication software development kit. The computer-readable medium can be stored on any suitable computer-readable media such as RAMs, ROMs, flash memory, EEPROMs, optical devices, hard drives, SSDs or any suitable device. The computer-executable component is preferably a general or application specific processor, but any suitable dedicated hardware or hardware/firmware combination device can alternatively or additionally execute the instructions.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (e.g., TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

The methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

### Use Cases

The methods and systems disclosed herein provide multiple advantages over existing methods and may be applied in a range of applications and contexts. In one exemplary and non-limiting context, the two factor authentication technology disclosed herein may be used in conjunction with a standard federated single sign-on (SSO) system for providing authentication for the multiple cloud based applications. In such an implementation, the user is able to access all the different applications of the SSO system in a secure and frictionless manner without having to use any additional hardware or software tokens while accessing such applications.

In various embodiments, the two factor authentication technology is implemented as a web application, a network resource, or a software-as-a-service (SaaS) cloud application, or a native mobile application in an enterprise environment. The application may utilize data connectors to on-premise data stores such as enterprise directory that may run active directory LDAP, SQL, or other data storage and user information repositories.

In another exemplary embodiment the two factor authentication (2FA) technology disclosed herein is provided in the form of an application programming interface (API) and integrated with standalone systems for providing two factor authentication. In such an embodiment, the 2FA application programming interface (API) functions to provide a programmatic interface for outside applications. The 2FA API may accepts API calls or requests from various services. In one implementation of the 2FA API, a service provider enters a state where a user is attempting to complete some task requiring authentication (e.g., login, perform a sensitive transaction), and the service provider will then make an API call through the authentication API that initiates the two factor authentication process. The 2FA API is preferably an application layer protocol (e.g., HTTP, HTTPS, SPDY, etc.) based API and may be any suitable type of API such as a REST, SOAP, or other suitable form of API.

Embodiments of the present technology allow for the construction and use of two factor authentication modules to integrate with third party application clients. For example, an enterprise can embed the 2FA software development kit (SDK) into its proprietary device application for the two factor authentication processes with their web service(s). The 2FA SDK is preferably a software module integrated in a device application. The 2FA SDK may be provided as source code configuration or as compiled binary version of the 2FA SDK. A developer of the device application will preferably include or link the 2FA SDK components such that the methods, data, and operational logic in the device application

In another exemplary and non-limiting context, the two factor authentication technology is implemented in the form of a web-based or native mobile application integrated with a banking or mobile payment application. In such implementation, the end user of the banking or mobile payment application is authenticated using the two factor authentication technology in a frictionless and secure manner without requiring the use of any one time passwords (OTPs), or hardware tokens.

In another exemplary and non-limiting context, the two factor authentication technology is implemented as an application integrated with a virtual cryptocurrency wallet like bitcoin wallet. Such implementation builds on top of public key cryptography used in bitcoin wallets and the key based authentication is superior to token based authentication requiring centralized storage of passwords.

In another exemplary and non-limiting context, the two factor authentication technology is implemented as an application integrated with the “internet of things” comprised of sensors, tags, doors, appliances, vehicles, devices, meters, machines, cameras, computers, etc., in order to prevent cloning, spoofing and replay attacks. In such an implementation, the user may register the different devices one by one and then is authenticated using the two factor authentication technology in a frictionless and secure manner

In another exemplary and non-limiting context, the two factor authentication technology is implemented as a password manger application. In such an implementation all user passwords are stored in an encrypted state and are dynamically decrypted and provided to the user for login, only once the user has been authenticated. The key used for encryption is neither stored on the user device nor on the authentication server but derived at the end of the two factor authentication of the user. Thus, the two factor authentication technology disclosed herein solves an important weakness of the current breed of password managers that typically use a single master password chosen by the customer to control access to all the user passwords.

In one embodiment, the two factor authentication system may optionally include an extra layer of risk-based analysis, to inspect one or more elements such as the IP address acceptance range, an IP address risk attribute, and/or a geo-velocity of the user (e.g., the distance and time between a last login and a current login). The returned attributes can then be taken into account to step-up the authentication process.

It will be apparent to one skilled in the art that the two factor authentication technology disclosed herein can be used for augmenting authentication provided through a wide range of existing protocols and technologies.

It will be apparent that in addition to the above representative examples, the methods and systems disclosed herein could be applicable to a wide range of applications a wide range of industries including but not limited to Healthcare, Banking, Financial Services and Insurance (BFSI), Government, Biotech and Pharmaceuticals, Telecom and IT, Retail and E-commerce. The methods and systems are particularly useful in industries where data security requirements are relatively more stringent like for example the healthcare and financial services industries. For example, companies in the financial services industry across the world are required by regulation to provide strong authentication and meet standards like PCI-DSS (Payment Card Industry- Data Security Standards). Similarly, healthcare industry has stringent security and authentication requirements, standards like HIPAA (Health Insurance Portability and Accountability Act) and HITECH (Health Information Technology for Economic and Clinical Health) and wide variety of data usage policies that must be complied with by any users of healthcare data.

It will be apparent that the methods and systems disclosed herein may find applications in key management, device management and identity management as described below.

Key Management: Key management deals with various aspects of managing cryptographic keys in a security system. It covers aspects of key generation and distribution, updating of keys, procedures around key validation, key suspension and handling key compromise. While lack of key management policies can render systems insecure, overtly complicated key management can result in low usage of several security mechanisms. In fact, complicated procedures around public keys management is seen as a major reason for low adoption of public key based security systems in the enterprise scenario. The two factor authentication method disclosed herein is based on a very efficient public key management system. Users can generate fresh keys at any time on any device. These keys are neither stored on any one device nor have to be memorized by users, thus making it very difficult to compromise them. The keys are refreshed whenever the user chooses a new password. In case of compromise of the user's device or the authentication server, all user keys still remain secure as they are not stored in one place completely. Thus, in the two factor authentication method disclosed herein all the benefits of public key crypto systems are provided without the cumbersome procedures of public key management.

Device Management: As the number of devices used by a typical enterprise (and consumer) user increase, new issues around usability and security are emerging. As the users want to be able to access services from any device, typically access control is independent of devices and mostly centered around user authentication via passwords. But this poses security challenges, as users tend to have several mobile devices which are susceptible to loss/theft, also, user devices may have rogue software running on them. Thus, security issues of data confidentiality and access control emerge. Any sensitive data stored on the phone needs to be protected, similarly any access tokens stored (most popular way of accessing mobile apps) on the phone need to be protected as well. Thus, typically enterprises need to employ separate Mobile Device Management (MDM) solutions which are mostly agent based software that protect the stored data and wipe the data when it detects a device compromise. While MDM solutions do offer some protection they are not popular due to several reasons. Users also tend to have personal information on phone and thus dislike the presence of a remote agent on their device which can not only monitor all personal data but can also potentially delete it. Also, most MDM solutions become ineffective if the device is not connected to the base station (i.e. in case of loss of connectivity). The two factor authentication system disclosed herein offers a very unique way for securing data on mobile devices as well as enforce access control even when the device is in full control of an attacker. The system keeps all sensitive data encrypted on the user mobile device, and the key used for encryption is deleted as soon as the user logs out or after a timeout, whereby the data is returned to its encrypted state. The key can only be recovered by supplying the user password in a live authentication protocol with the server. Thus, if the attacker has access to a user device and is disconnected from the network, all it gets is encrypted data with no way of getting to the key. As no authentication tokens are stored either, the user can not access any service either without providing the correct password in a live interaction. Further benefit is that the a user can disable a particular compromised device without any impact on its other devices or the password.

Identity Management: Identifying users and devices is a crucial step to implement security policies within an enterprise. Traditionally, usernames (or identifiers) are the cornerstone of identity management in an enterprise, and thus devices are controlled and managed by separate software or policies. The 2FA method disclosed herein provides a unique proposition whereby a username and a device combination are viewed as a separate identity. Thus, the same user coming from different devices can be possibly viewed as a separate identity and different access mechanisms can be applied on them.

The methods and systems described herein may transform physical and/or or intangible items from one state to another. The methods and systems described herein may also transform data representing physical and/or intangible items from one state to another.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

While the methods and systems described herein have been disclosed in connection with certain preferred embodiments shown and described in detail, various modifications and improvements thereon may become readily apparent to those skilled in the art.

Accordingly, the spirit and scope of the methods and systems described herein is not to be limited by the foregoing examples, but is to be understood in the broadest sense allowable by law. All documents referenced herein are hereby incorporated by reference.

What is claimed is:

1. A method for providing two factor authentication for a user using a system comprising a user device, an authentication server, and a network interconnecting the user device and authentication server, the method comprising the steps of:
registering the user by:
receiving a password from the user;
generating a key K;
splitting key K into two key shares K1 and K2;
storing key share K1 on the user device and sending an authentication token for key K and key share K2 blinded by the password to the authentication server;
authenticating the user by:
receiving a password from the user;
retrieving key share K2 using the password received from the user and the blinded key share of K2 received from the authentication server;
combining the retrieved key share K2 with stored key share K1 to compute key K;
implementing a standard key based authentication protocol between the user and the authentication server using key K and authentication token for key K.

2. The method for providing two factor authentication as in claim 1 wherein implementing a standard key based authentication protocol comprises implementing a public key protocol.

3. The method for providing two factor authentication in claim 2 wherein the public key protocol is Schnorr identification protocol.

4. The method for providing two factor authentication as in claim 1 wherein implementing a standard key based authentication protocol comprises utilising a symmetric key protocol.

5. The method for providing two factor authentication in claim 4 wherein the symmetric key protocol is keyed message authentication code protocol.

6. The method for providing two factor authentication as in claim 1 wherein implementing a standard key based authentication protocol comprises implementing a public key zero knowledge protocol.

7. The method for providing two factor authentication for a user as in claim 1 wherein splitting key K into two key shares K1 and K2 is performed using a secret sharing protocol.

8. The method for providing two factor authentication for a user as in claim 1 further comprising deriving a cryptographic key Ke from key K for a symmetric key crypto system.

9. The method for providing two factor authentication for a user as in claim 1 further comprising deriving a cryptographic key pair (Kes, Kep) from key K for an asymmetric key crypto system.

10. A system for providing two factor authentication for a user comprising a user device;
an authentication server;
a network interconnecting the user device and authentication server;
software on the user device and authentication server that cooperates to first register the user by storing a first key share K1 of an authentication key K on the user device and storing a second key share K2 of K blinded by a user chosen password on the authentication server, and then authenticate the user by implementing a standard key based authentication protocol between the user and the authentication server using the authentication key K computed by combining key share K1 stored on the user device with key share K2 derived using the password received from the user and the blinded key share of K2 received from the authentication server

11. The system for providing two factor authentication for a user as in claim 10, wherein the authentication server controls access to a plurality of applications and permits the user to access any of the plurality of applications if the user is authenticated, thereby providing a single sign-on (SSO) feature.

12. The system for providing two factor authentication for a user as in claim 11 wherein the plurality of applications are hosted in the cloud

13. The system for providing two factor authentication for a user as in claim 10 wherein the user device is selected from a group consisting of: computer, smartphone, laptop, tablet, wearable device, gaming device, and internet of things (IoT) device.

14. The system for providing two factor authentication for a user as in claim 10 wherein the user device includes an application selected from a group consisting of: banking application, mobile wallet application, payment gateway application, password manager application and virtual cryptocurrency wallet application.

15. The system for providing two factor authentication for a user as in claim 14 wherein the virtual cryptocurrency wallet application is a bitcoin wallet application.

16. The system for providing two factor authentication for a user as in claim 10 wherein the user device comprises a biometric input device for receiving biometric information from the user.

17. The system for providing two factor authentication for a user as in claim 10 wherein the two factor authentication system is implemented as a web application.

18. The system for providing two factor authentication for a user as in claim 10 wherein the two factor authentication system is implemented as a native mobile application.

19. The system for providing two factor authentication for a user as in claim 10 wherein the system is used for securing multiple user devices belonging to the user.

20. A computer program product for authenticating a user using a system comprising a user device, an authentication server, and a network interconnecting the user device and authentication server, the computer program product being embodied in a non-transitory computer readable storage medium and comprising computer instructions for:
registering the user by:
receiving a password from the user;
generating a key K;
splitting key K into two key shares K1 and K2 ;
storing key share K1 on the user device and sending an authentication token for key K and key share K2 blinded by the password to the authentication server;
authenticating the user by:
receiving a password from the user;
retrieving key share K2 using knowledge of password and the blinded key share of K2 received from authentication server;
combining the retrieved key share K2 with stored key share K1 to compute key K;
implementing a standard authentication protocol between the user and the authentication server using key K and authentication token for key K.
